(19) United States
(12) Patent Application Publication
(10) Pub. No.: US 2024/0331939 A1
(43) Pub. Date: Oct. 3, 2024

(54) COMPOSITE MATERIAL FOR MANUFACTURING INDUCTOR, INDUCTOR AND PROCESS OF MANUFACTURING INDUCTOR

(71) Applicants: Zhongshan Skcoil Electronics Co., LTD, Zhongshan (CN); Zhongshan ZenithTek Technology Co., Ltd., Zhongshan (CN); Zhongshan ZenithTek Electronic Co., Ltd., Zhongshan (CN); Zenith Tek Inc., New Taipei (TW)

(72) Inventor: Liang Jun Qin, Zhongshan (CN)

(21) Appl. No.: 18/383,935

(22) Filed: Oct. 26, 2023

(30) Foreign Application Priority Data
Mar. 31, 2023 (CN) 2023103378232

(51) Int. Cl. H01F 41/064; B22F 3/00; B22F 3/02; B22F 3/24; B22F 5/00; C22C 38/00; C22C 38/02

(52) U.S. Cl. CPC H01F 41/064; B22F 3/004; B22F 3/02; B22F 3/24; B22F 5/00; C22C 38/002; C22C 38/02; B22F 2003/242; B22F 2003/248; B22F 2301/35; B22F 2998/10; B22F 2999/00

(57) ABSTRACT

A process of manufacturing inductor includes preparing coil, using a composite material to prepare a T-core and a U-core, disposing the coil in the cavity of the U-core with the extensions disposed externally of the cavity, inserting the projection through the coil with the cavity being covered by the platform, bending the extensions, heating the assembled U-core, the coil, and the T-core to form a half-finished product, baking the half-finished product, painting and peeling the baked half-finished product, and surface treating the peeled half-finished product by electroplating a composite layer on exposed surfaces of the extensions to obtain an inductor. The composite layer includes, from inside to outside, a copper layer, a nickel layer, and a tin layer.

### FIELD OF THE INVENTION

The invention relates to inductors and more particularly to a composite material for manufacturing inductor, inductor and process of manufacturing inductor.

### BACKGROUND OF THE INVENTION

An inductor, also called a coil, choke, or reactor, is a passive two-terminal electrical component that stores energy in a magnetic field when electric current flows through it. Conventionally, an inductor consists of an insulated wire wound into a coil.

There is an integral inductor commercially available and the inductor comprises a metallic magnetic block and a winding including a body formed of metallic wire disposed in the metallic magnetic block, and two terminals disposed externally of the metallic magnetic block. The coil is helical.

Three types of conventional integral inductor are shown in FIGS. 3, 4 and 5 respectively. In FIG. 3, an A series inductor is shown. First, an insulated wire is wound into a coil which in turn is placed in a mold, a composite material is poured into the mold, and finally the material is compacted rectangular magnetic to form the A series inductor. In FIG. 4, a B series inductor is shown. First, an insulated wire is wound into a coil which in turn is placed in a mold, a composite material is poured into the mold, and finally the material is compacted warmly by PM to form the B series inductor. In FIG. 5, a C series inductor is shown. First, T-core is formed by PM, an insulated wire is wound into a coil on the T-core, both the coil and the T-core are placed in a mold, a composite material is poured into the mold, and finally the material is compacted warmly by PM to form the C series inductor. Both A and B series inductors are disadvantageous because a central portion of the coil has a lower compaction density, the coil is deformed, and poor performance. While the C series inductor has a higher density due to the T-core, other portions thereof have a lower compaction density. Further, it is deformed and has poor performance.

Thus, the need for improvement still exists.

### SUMMARY OF THE INVENTION

It is therefore one object of the invention to provide a process of manufacturing inductor comprising the steps of preparing coil by winding a rectangular magnetic copper wire to form a coil having two parallel extensions in a horizontal direction, bending the extensions to dispose vertically with respect to the coil, and removing insulation layer of the magnetic copper wire from the extensions; using a composite material to prepare a T-core and a U-core by adding epoxy resin and coupling agent to a solution to form a first mixture, adding carbonyl iron powder and amorphous powder to the first mixture, agitating the first mixture to form a second mixture, processing the second mixture to form a plurality of particles, adding zinc stearate to the particles to form a third mixture, pouring the third mixture into a mold, and cooling the mold at a predetermined pressure by powder metallurgy (PM) for a predetermined time to form the T-core and the U-core wherein the T-core includes a platform and a projection extending downward from the platform and the U-core includes a cavity on a top; disposing the coil in the cavity of the U-core with the extensions disposed externally of the cavity; inserting the projection through the coil with the cavity being covered by the platform; bending the extensions; heating the assembled U-core, the coil, and the T-core at a predetermined temperature and at a predetermined pressure by PM for a predetermined time to form a half-finished product; baking the half-finished product at a predetermined temperature for a predetermined time; painting and peeling the baked half-finished product; and surface treating the peeled half-finished product by electroplating a composite layer on exposed surfaces of the extensions to obtain an inductor wherein the composite layer includes, from inside to outside, a copper layer, a nickel layer, and a tin layer.

Preferably, the predetermined temperature is between 160° C. and 180° C., the predetermined pressure is between 5.0T/cm² and 6.0T/cm², and the predetermined time is between 50 sec and 80 sec.

Preferably, the mixture is compacted at the predetermined pressure of 3.5T/cm² to 4.0T/cm² for the predetermined time of 1 sec to 2 sec.

Preferably, the copper layer has a thickness of 2 μm to 4 μm, the nickel layer has a thickness of 1 μm to 3 μm, and the tin layer has a thickness of 6 μm to 8 μm.

Preferably, the half-finished product is baked at the predetermined temperature for the predetermined time at eight periods, and wherein at a first period the predetermined temperature is 80±5° C. and the predetermined time is 30±3 min, at a second period the predetermined temperature is 100±5° C. and the predetermined time is 30±3 min, at a third period the predetermined temperature is 120±5° C. and the predetermined time is 30±3 min, at a fourth period the predetermined temperature is 140±5° C. and the predetermined time is 30±3 min, at a fifth period the predetermined temperature is 160±5° Cand the predetermined time is 120±3 min, at a sixth period the predetermined temperature is 140±5° C. and the predetermined time is 15±3 min, at a seventh period the predetermined temperature is 120±5° C. and the predetermined time is 15±3 min, and at an eighth period the predetermined temperature is 100±5° C. and the predetermined time is 15±3 min.

The invention has the following advantages and benefits in comparison with the conventional art:

A specific composite material is used and a specific cool shaping technology is chosen to cooperate with the specific composite material. T-core and U-core are prepared. The coil is placed in the cavity of the U-core. The projection of the T-core is placed in the through hole of the coil. The cavity of the U-core is covered by the platform. Heat shaping technology is used to form a half-finished product. The inductor of the invention is without drawbacks of the conventional inductor including low density, deformation, poor performance and high energy loss. A number of heating periods of time are used to heat the half-finished product. Thus, the inductor of the invention has a decreased probability of being cracked, and is without the problem of being subject to thermal expansion due to quick high temperature curing.

The above and other objects, features and advantages of the invention will become apparent from the following detailed description taken with the accompanying drawings

### BRIEF DESCRIPTION OF THE DRAWINGS

FIG. 1 schematically depicts a process of manufacturing inductor according to the invention and the manufactured inductor;

FIG. 2 is a table showing performance test results of the inductors manufactured by first to third embodiments and first to sixth comparison examples in terms of inductance, current and energy loss;

FIG. 3 is a photograph showing a conventional A series inductor;

FIG. 4 is a photograph showing a conventional B series inductor;

FIG. 5 is a photograph showing a conventional C series inductor.

### DETAILED DESCRIPTION OF THE INVENTION

In the following description, epoxy resin is produced by Yongkang Chemical Company and its serial number is NF552; coupling agent is silane coupling agent, is produced by Tenwei Company, and its serial number is KH-550; and zinc stearate is produced by Seno New Material Company.

Coil has two sizes in which the first one is 5.1 mm (L)×5.3 mm (W)×3.0 mm (H), and the second one is 6.0 mm (L)×6.0 mm (W)× 3.1 mm (H). It is noted that in comparison examples 4 to 6, sizes are changed in which the height is unchanged, the length is increased by 0.3 mm, and the width is increased 0.3 mm.

### A FIRST EMBODIMENT

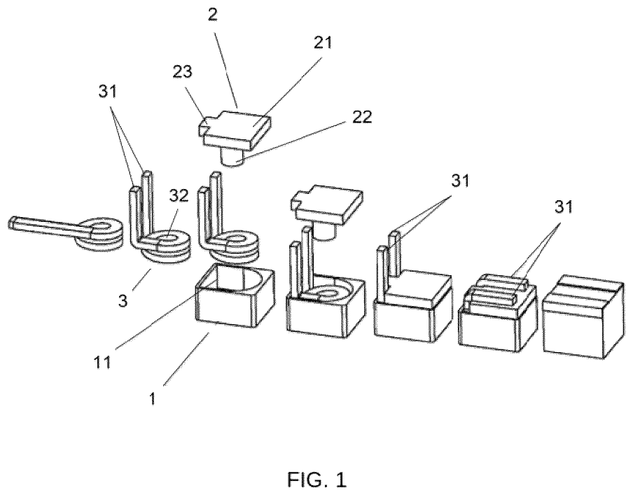

Referring to FIG. 1, a process of manufacturing inductor in accordance with the invention comprises the following steps:

Coil preparation. A winding machine is used to wind a rectangular magnetic copper wire to form a coil 3 having two parallel extensions 31 in a horizontal direction. The extension 31 are bent 90 degrees to dispose vertically with respect to the coil 3. A laser device is used to remove the insulation layer of magnetic copper wire from the extensions 31.

A composite material is used to prepare T-core and U-core in which the composite material is comprised of 70 wt % of carbonyl iron powder, 25 wt % of amorphous powder, 4 wt % of epoxy resin, 0.3 wt % of silane coupling agent, and 0.7 wt % of zinc stearate. Amorphous powder is comprised of 3.0 wt % of Si, 4.0 wt % of B, 1.0 wt % of C, 0.03 wt % of P, 0.01 wt % of S, and 91.96 wt % of Fe.

Preparations of U-core 1 and T-core 2 are detailed below.

Epoxy resin and silane coupling agent are added to ethanol to form a first mixture. Carbonyl iron powder and amorphous powder are added to the first mixture. The first mixture is agitated to volatilize ethanol until a colloidal second mixture is formed. The second mixture is poured into a granulation machine having a mesh of 100 to form a plurality of particles. The particles are heated at 45□ for two hours. Next, the particles pass a filter having a mesh of 100. Zinc stearate is added to the filtered particles which are in turn rotated at a speed of100 revolution/min for 0.5 hour for mixing. The particles are poured into a mold which is in turn at a predetermined pressure by PM for a predetermined time to form T-core 2 and U-core 1. The T-core 2 includes a platform 21 and a projection 22 extending downward from the platform 21. The platform 21 is substantially shaped as a square and has a side protrusion 23 so that the extensions 31 may through two ends of the side protrusion 23. The projection 22 is inserted through a through hole 32 of the coil 3 to fasten the T-core 2 and the coil 3 together. The U-core 1 includes a cavity 11 on a top with the coil 3 fastened therein. The predetermined pressure is 3.5T/cm² and the predetermined time is 2 sec. The added ethanol is 25% of the total weight of the epoxy resin, silane coupling agent, carbonyl iron powder and amorphous powder.

The coil 3 is placed in the cavity 11 of the U-core 1 and the extensions 31 are disposed externally of the cavity 11.

The T-core 2 is placed in the through hole 32 of the coil 3. The through hole 32 of the coil 3 is covered by the platform 21. The extensions 31 are bent 55° so that the extensions 31 are disposed at an angle of 35° with respect to the platform 21.

The assembled U-core 1, the coil 3 and the T-core 2 are heated at 180□ at a pressure of 5.5T/cm² by PM for 50 sec to form a half-finished product.

The half-finished product is put into an oven to bake at a predetermined temperature for a predetermined time at eight periods as detailed below. At a first period, heating temperature is 80° C. and heating time is 30 min. At a second period, heating temperature is 100° C. and heating time is 30 min. At a third period, heating temperature is 120° C. and heating time is 30 min. At a fourth period, heating temperature is 140° C. and heating time is 30 min. At a fifth period, heating temperature is 160 and heating time is 120 min. At a sixth period, heating temperature is 140: and heating time is 150 min. At a seventh period, heating temperature is 120 and heating time is 15 min. At an eighth period, heating temperature is 100 and heating time is 15 min.

Painting and peeling of the half-finished product in which the painting involves painting an insulative paint on the half-finished product and the peeling involves removing paint from the extensions of the painted half-finished product to expose the copper wire.

Surface treatment in which a composite layer is electroplated on the exposed wire and surfaces of the extensions to obtain an inductor. The composite layer includes, from inside to outside, a copper layer having a thickness of 3 μm, a nickel layer having a thickness of 2 μm and a tin layer having a thickness of 7 μm. The electroplated composite layer on the side is located at ⅙ position from an upper surface of the inductor to a side thereof, calculated from top to bottom.

As shown in FIG. 1, the inductor manufactured by the process of the embodiment comprises a U-core 1, a coil 3 and a T-core 2. The U-core 1 includes a cavity 11 with the coil 3 fitted therein. The T-core 2 includes a platform 21 and a projection 22 extending downward from the platform 21. The projection 22 is inserted through the through hole 32 of the coil 3. The coil 3 includes two parallel extensions 31 which are disposed externally of the cavity 11. The cavity 11 is covered by the platform 21. The extensions 31 are bent to dispose on a top of the platform 21. An insulative paint is coated on the inductor except the extensions 31. Surface of the extension is coated with, from inside to outside, a copper layer, a nickel layer and a tin layer. The side protrusion 23 of the T-core 2 is inserted through a gap between the extensions 31 of the coil 3.

### A SECOND EMBODIMENT

Referring to FIG. 1, a process of manufacturing inductor in accordance with the invention comprises the following steps:

Coil preparation. A winding machine is used to wind a rectangular magnetic copper wire to form a coil 3 having two parallel extensions 31 in a horizontal direction. The extension 31 are bent 90 degrees to dispose vertically with respect to the coil 3. A laser device is used to remove the insulation layer of magnetic copper wire from the extensions 31.

A composite material is used to prepare T-core and U-core in which the composite material is comprised of 75 wt % of carbonyl iron powder, 20 wt % of amorphous powder, 4 wt % of epoxy resin, 0.3 wt % of silane coupling agent, and 0.7 wt % of zinc stearate. Amorphous powder is comprised of 3.0 wt % of Si, 4.0 wt % of B, 1.0 wt % of C, 0.03 wt % of P, 0.01 wt % of S, and 91.96 wt % of Fe.

Preparations of U-core 1 and T-core 2 are detailed below.

Epoxy resin and silane coupling agent are added to ethanol to form a first mixture. Carbonyl iron powder and amorphous powder are added to the first mixture. The first mixture is agitated to volatilize ethanol until a colloidal second mixture is formed. The second mixture is poured into a granulation machine having a mesh of 100 to form a plurality of particles. The particles are heated at 45° C. for two hours. Next, the particles pass a filter having a mesh of 100. Zinc stearate is added to the filtered particles which are in turn rotated at a speed of 100 revolution/min for 0.5 hour for mixing. The particles are poured into a mold which is in turn at a predetermined pressure by PM for a predetermined time to form T-core 2 and U-core 1. The T-core 2 includes a platform 21 and a projection 22 extending downward from the platform 21. The platform 21 is substantially shaped as a square and has a side protrusion 23 so that the extensions 31 may through two ends of the side protrusion 23. The projection 22 is inserted through a through hole 32 of the coil 3 to fasten the T-core 2 and the coil 3 together. The U-core 1 includes a cavity 11 on a top with the coil 3 fastened therein. The predetermined pressure is 3.5T/cm² and the predetermined time is 2 sec. The added ethanol is 25% of the total weight of the epoxy resin, silane coupling agent, carbonyl iron powder and amorphous powder.

The coil 3 is placed in the cavity 11 of the U-core 1 and the extensions 31 are disposed externally of the cavity 11.

The T-core 2 is placed in the through hole 32 of the coil 3. The through hole 32 of the coil 3 is covered by the platform 21. The extensions 31 are bent 55° so that the extensions 31 are disposed at an angle of 35° with respect to the platform 21.

The assembled U-core 1, the coil 3 and the T-core 2 are heated at 180□ at a pressure of 5.5T/cm² by PM for 50 sec to form a half-finished product.

The half-finished product is put into an oven to bake at a predetermined temperature for a predetermined time at eight periods as detailed below. At a first period, heating temperature is 80° C. and heating time is 30 min. At a second period, heating temperature is 100° C. and heating time is 30 min. At a third period, heating temperature is 120° C. and heating time is 30 min. At a fourth period, heating temperature is 140° C. and heating time is 30 min. At a fifth period, heating temperature is 160 and heating time is 120 min. At a sixth period, heating temperature is 140 and heating time is 15 min. At a seventh period, heating temperature is 120 and heating time is 15 min. At an eighth period, heating temperature is 100 and heating time is 15 min.

Painting and peeling of the half-finished product in which the painting involves painting an insulative paint on the half-finished product and the peeling involves removing paint from the extensions of the painted half-finished product to expose the copper wire.

Surface treatment in which a composite layer is electroplated on the exposed wire and surfaces of the extensions to obtain an inductor. The composite layer includes, from inside to outside, a copper layer having a thickness of 3 μm, a nickel layer having a thickness of 2 μm and a tin layer having a thickness of 7 μm. The electroplated composite layer on the side is located at ⅙ position from an upper surface of the inductor to a side thereof, calculated from top to bottom.

The inductor of the second embodiment is the same as that of the first embodiment.

### A THIRD EMBODIMENT

Referring to FIG. 1, a process of manufacturing inductor in accordance with the invention comprises the following steps:

Coil preparation. A winding machine is used to wind a rectangular magnetic copper wire to form a coil 3 having two parallel extensions 31 in a horizontal direction. The extension 31 are bent 90 degrees to dispose vertically with respect to the coil 3. A laser device is used to remove the insulation layer of magnetic copper wire from the extensions 31.

A composite material is used to prepare T-core and U-core in which the composite material is comprised of 73 wt % of carbonyl iron powder, 23 wt % of amorphous powder, 3 wt % of epoxy resin, 0.3 wt % of silane coupling agent, and 0.7 wt % of zinc stearate. Amorphous powder is comprised of 3.0 wt % of Si, 4.0 wt % of B, 1.0 wt % of C, 0.03 wt % of P, 0.01 wt % of S, and 91.96 wt % of Fe.

Preparations of U-core 1 and T-core 2 are detailed below.

Epoxy resin and silane coupling agent are added to ethanol to form a first mixture. Carbonyl iron powder and amorphous powder are added to the first mixture. The first mixture is agitated to volatilize ethanol until a colloidal second mixture is formed. The second mixture is poured into a granulation machine having a mesh of 100 to form a plurality of particles. The particles are heated at 45° C. for two hours. Next, the particles pass a filter having a mesh of 100. Zinc stearate is added to the filtered particles which are in turn rotated at a speed of 100 revolution/min for 0.5 hour for mixing. The particles are poured into a mold which is in turn at a predetermined pressure by PM for a predetermined time to form T-core 2 and U-core 1. The T-core 2 includes a platform 21 and a projection 22 extending downward from the platform 21. The platform 21 is substantially shaped as a square and has a side protrusion 23 so that the extensions 31 may through two ends of the side protrusion 23. The projection 22 is inserted through a through hole 32 of the coil 3 to fasten the T-core 2 and the coil 3 together. The U-core 1 includes a cavity 11 on a top with the coil 3 fastened therein. The predetermined pressure is 3.5T/cm² and the predetermined time is 2 sec. The added ethanol is 25% of the total weight of the epoxy resin, silane coupling agent, carbonyl iron powder and amorphous powder.

The coil 3 is placed in the cavity 11 of the U-core 1 and the extensions 31 are disposed externally of the cavity 11.

The T-core 2 is placed in the through hole 32 of the coil 3. The through hole 32 of the coil 3 is covered by the platform 21. The extensions 31 are bent 55° so that the extensions 31 are disposed at an angle of 35° with respect to the platform 21.

The assembled U-core 1, the coil 3 and the T-core 2 are heated at 180□ at a pressure of 5.5T/cm² by PM for 50 sec to form a half-finished product.

The half-finished product is put into an oven to bake at a predetermined temperature for a predetermined time at eight periods as detailed below. At a first period, heating temperature is 80° C. and heating time is 30 min. At a second period, heating temperature is 100° C. and heating time is 30 min. At a third period, heating temperature is 120° C. and heating time is 30 min. At a fourth period, heating temperature is 140° C. and heating time is 30 min. At a fifth period, heating temperature is 160° C. and heating time is 120 min. At a sixth period, heating temperature is 140° C. and heating time is 15 min. At a seventh period, heating temperature is 120° C. and heating time is 15 min. At an eighth period, heating temperature is 100° C. and heating time is 15 min.

Painting and peeling of the half-finished product in which the painting involves painting an insulative paint on the half-finished product and the peeling involves removing insulation layer of the magnetic copper wire from the extensions of the painted half-finished product to expose the magnetic copper wire.

Surface treatment in which a composite layer is electroplated on the exposed wire and surfaces of the extensions to obtain an inductor. The composite layer includes, from inside to outside, a copper layer having a thickness of 3 μm, a nickel layer having a thickness of 2 μm and a tin layer having a thickness of 7 μm. The electroplated composite layer on the side is located at ⅙ position from an upper surface of the inductor to a side thereof, calculated from top to bottom.

The inductor of the third embodiment is the same as that of the first embodiment.

### First Comparison Example

Referring to FIG. 1, a process of manufacturing inductor in accordance with the invention comprises the following steps:

Coil preparation. A winding machine is used to wind a rectangular magnetic copper wire to form a coil 3 having two parallel extensions 31 in a horizontal direction. The extension 31 are bent 90 degrees to dispose vertically with respect to the coil 3. A laser device is used to remove the insulation layer of magnetic copper wire from the extensions 31.

A composite material is used to prepare T-core and U-core in which the composite material is comprised of 80 wt % of carbonyl iron powder, 15 wt % of amorphous powder, 4 wt % of epoxy resin, 0.3 wt % of silane coupling agent, and 0.7 wt % of zinc stearate. Amorphous powder is comprised of 3.0 wt % of Si, 4.0 wt % of B, 1.0 wt % of C, 0.03 wt % of P, 0.01 wt % of S, and 91.96 wt % of Fe.

Preparations of U-core 1 and T-core 2 are detailed below.

Epoxy resin and silane coupling agent are added to ethanol to form a first mixture. Carbonyl iron powder and amorphous powder are added to the first mixture. The first mixture is agitated to volatilize ethanol until a colloidal second mixture is formed. The second mixture is poured into a granulation machine having a mesh of 100 to form a plurality of particles. The particles are heated at 45° C. for two hours. Next, the particles pass a filter having a mesh of 100. Zinc stearate is added to the filtered particles which are in turn rotated at a speed of 100 revolution/min for 0.5 hour for mixing. The particles are poured into a mold which is in turn at a predetermined pressure by PM for a predetermined time to form T-core 2 and U-core 1. The T-core 2 includes a platform 21 and a projection 22 extending downward from the platform 21. The platform 21 is substantially shaped as a square and has a side protrusion 23 so that the extensions 31 may through two ends of the side protrusion 23. The projection 22 is inserted through a through hole 32 of the coil 3 to fasten the T-core 2 and the coil 3 together. The U-core 1 includes a cavity 11 on a top with the coil 3 fastened therein. The predetermined pressure is 3.5T/cm² and the predetermined time is 2 sec. The added ethanol is 25% of the total weight of the epoxy resin, silane coupling agent, carbonyl iron powder and amorphous powder.

The coil 3 is placed in the cavity 11 of the U-core 1 and the extensions 31 are disposed externally of the cavity 11.

The T-core 2 is placed in the through hole 32 of the coil 3. The through hole 32 of the coil 3 is covered by the platform 21. The extensions 31 are bent 55° so that the extensions 31 are disposed at an angle of 35° with respect to the platform 21.

The assembled U-core 1, the coil 3 and the T-core 2 are heated at 180□ at a pressure of 5.5T/cm² by PM for 50 sec to form a half-finished product.

The half-finished product is put into an oven to bake at a predetermined temperature for a predetermined time at eight periods as detailed below. At a first period, heating temperature is 80° C. and heating time is 30 min. At a second period, heating temperature is 100° C. and heating time is 30 min. At a third period, heating temperature is 120° C. and heating time is 30 min. At a fourth period, heating temperature is 140° C. and heating time is 30 min. At a fifth period, heating temperature is 160° C. and heating time is 120 min. At a sixth period, heating temperature is 140° C. and heating time is 15 min. At a seventh period, heating temperature is 120° C. and heating time is 15 min. At an eighth period, heating temperature is 100° C. and heating time is 15 min.

Painting and peeling of the half-finished product in which the painting involves painting an insulative paint on the half-finished product and the peeling involves removing paint from the extensions of the painted half-finished product to expose the copper wire.

Surface treatment in which a composite layer is electroplated on the exposed wire and surfaces of the extensions to obtain an inductor. The composite layer includes, from inside to outside, a copper layer having a thickness of 4 μm, a nickel layer having a thickness of 2 μm and a tin layer having a thickness of 6 μm. The electroplated composite layer on the side is located at ⅙ position from an upper surface of the inductor to a side thereof, calculated from top to bottom.

The inductor of the first comparison example is the same as that of the first embodiment.

### A Second Comparison Example

Referring to FIG. 1, a process of manufacturing inductor in accordance with the invention comprises the following steps:

Coil preparation. A winding machine is used to wind a rectangular magnetic copper wire to form a coil 3 having two parallel extensions 31 in a horizontal direction. The extension 31 are bent 90 degrees to dispose vertically with respect to the coil 3. A laser device is used to remove the insulation layer of magnetic copper wire from the extensions 31.

A composite material is used to prepare T-core and U-core in which the composite material is comprised of 70 wt % of carbonyl iron powder, 25 wt % of amorphous powder, 3 wt % of epoxy resin, 1 wt % of silane coupling agent, and 1 wt % of zinc stearate. Amorphous powder is comprised of 3.0 wt % of Si, 4.0 wt % of B, 1.0 wt % of C, 0.03 wt % of P, 0.01 wt % of S, and 91.96 wt % of Fe.

Preparations of U-core 1 and T-core 2 are detailed below.

Epoxy resin and silane coupling agent are added to ethanol to form a first mixture. Carbonyl iron powder and amorphous powder are added to the first mixture. The first mixture is agitated to volatilize ethanol until a colloidal second mixture is formed. The second mixture is poured into a granulation machine having a mesh of 100 to form a plurality of particles. The particles are heated at 45° C. for two hours. Next, the particles pass a filter having a mesh of 100. Zinc stearate is added to the filtered particles which are in turn rotated at a speed of 100 revolution/min for 0.5 hour for mixing. The particles are poured into a mold which is in turn at a predetermined pressure by PM for a predetermined time to form T-core 2 and U-core 1. The T-core 2 includes a platform 21 and a projection 22 extending downward from the platform 21. The platform 21 is substantially shaped as a square and has a side protrusion 23 so that the extensions 31 may through two ends of the side protrusion 23. The projection 22 is inserted through a through hole 32 of the coil 3 to fasten the T-core 2 and the coil 3 together. The U-core 1 includes a cavity 11 on a top with the coil 3 fastened therein. The predetermined pressure is 3.5T/cm² and the predetermined time is 2 sec. The added ethanol is 25% of the total weight of the epoxy resin, silane coupling agent, carbonyl iron powder and amorphous powder.

The coil 3 is placed in the cavity 11 of the U-core 1 and the extensions 31 are disposed externally of the cavity 11.

The T-core 2 is placed in the through hole 32 of the coil 3. The through hole 32 of the coil 3 is covered by the platform 21. The extensions 31 are bent 55° so that the extensions 31 are disposed at an angle of 35° with respect to the platform 21.

The assembled U-core 1, the coil 3 and the T-core 2 are heated at 180□ at a pressure of 5.5T/cm² by PM for 50 sec to form a half-finished product.

The half-finished product is put into an oven to bake at a predetermined temperature for a predetermined time at eight periods as detailed below. At a first period, heating temperature is 80° C. and heating time is 30 min. At a second period, heating temperature is 100° C. and heating time is 30 min. At a third period, heating temperature is 120° C. and heating time is 30 min. At a fourth period, heating temperature is 140° C. and heating time is 30 min. At a fifth period, heating temperature is 160° C. and heating time is 120 min. At a sixth period, heating temperature is 140° C. and heating time is 15 min. At a seventh period, heating temperature is 120° C. and heating time is 15 min. At an eighth period, heating temperature is 100° C. and heating time is 15 min.

Painting and peeling of the half-finished product in which the painting involves painting an insulative paint on the half-finished product and the peeling involves removing paint from the extensions of the painted half-finished product to expose the copper wire.

Surface treatment in which a composite layer is electroplated on the exposed wire and surfaces of the extensions to obtain an inductor. The composite layer includes, from inside to outside, a copper layer having a thickness of 4 μm, a nickel layer having a thickness of 2 μm and a tin layer having a thickness of 6 μm. The electroplated composite layer on the side is located at ⅙ position from an upper surface of the inductor to a side thereof, calculated from top to bottom.

The inductor of the second comparison example is the same as that of the first embodiment.

### A Third Comparison Example

Referring to FIG. 1, a process of manufacturing inductor in accordance with the invention comprises the following steps:

Coil preparation. A winding machine is used to wind a rectangular magnetic copper wire to form a coil 3 having two parallel extensions 31 in a horizontal direction. The extension 31 are bent 90 degrees to dispose vertically with respect to the coil 3. A laser device is used to remove the insulation layer of magnetic copper wire from the extensions 31.

A composite material is used to prepare T-core and U-core in which the composite material is comprised of 70 wt % of carbonyl iron powder, 25 wt % of amorphous powder, 4 wt % of epoxy resin, 0.3 wt % of silane coupling agent, and 0.7 wt % of zinc stearate. Amorphous powder is comprised of 3.0 wt % of Si, 4.0 wt % of B, 1.0 wt % of C, 0.03 wt % of P, 0.01 wt % of S, and 91.96 wt % of Fe.

Preparations of U-core 1 and T-core 2 are detailed below.

Epoxy resin and silane coupling agent are added to ethanol to form a first mixture. Carbonyl iron powder and amorphous powder are added to the first mixture. The first mixture is agitated to volatilize ethanol until a colloidal second mixture is formed. The second mixture is poured into a granulation machine having a mesh of 100 to form a plurality of particles. The particles are heated at 45° C. for two hours. Next, the particles pass a filter having a mesh of 100. Zinc stearate is added to the filtered particles which are in turn rotated at a speed of 100 revolution/min for 0.5 hour for mixing. The particles are poured into a mold which is in turn at a predetermined pressure by PM for a predetermined time to form T-core 2 and U-core 1. The T-core 2 includes a platform 21 and a projection 22 extending downward from the platform 21. The platform 21 is substantially shaped as a square and has a side protrusion 23 so that the extensions 31 may through two ends of the side protrusion 23. The projection 22 is inserted through a through hole 32 of the coil 3 to fasten the T-core 2 and the coil 3 together. The U-core 1 includes a cavity 11 on a top with the coil 3 fastened therein. The predetermined pressure is 3.5T/cm² and the predetermined time is 2 sec. The added ethanol is 25% of the total weight of the epoxy resin, silane coupling agent, carbonyl iron powder and amorphous powder.

The coil 3 is placed in the cavity 11 of the U-core 1 and the extensions 31 are disposed externally of the cavity 11.

The T-core 2 is placed in the through hole 32 of the coil 3. The through hole 32 of the coil 3 is covered by the platform 21. The extensions 31 are bent 55° so that the extensions 31 are disposed at an angle of 35° with respect to the platform 21.

The assembled U-core 1, the coil 3 and the T-core 2 are heated at 160□ at a pressure of 7.0T/cm² by PM for 80 sec to form a half-finished product.

The half-finished product is put into an oven to bake at a predetermined temperature for a predetermined time at eight periods as detailed below. At a first period, heating temperature is 80° C. and heating time is 30 min. At a second period, heating temperature is 100° C. and heating time is 30 min. At a third period, heating temperature is 120° C. and heating time is 30 min. At a fourth period, heating temperature is 140° C. and heating time is 30 min. At a fifth period, heating temperature is 160° C. and heating time is 120 min. At a sixth period, heating temperature is 140° C. and heating time is 15 min. At a seventh period, heating temperature is 120° C. and heating time is 15 min. At an eighth period, heating temperature is 100° C. and heating time is 15 min.

Painting and peeling of the half-finished product in which the painting involves painting an insulative paint on the half-finished product and the peeling involves removing paint from the extensions of the painted half-finished product to expose the copper wire.

Surface treatment in which a composite layer is electroplated on the exposed wire and surfaces of the extensions to obtain an inductor. The composite layer includes, from inside to outside, a copper layer having a thickness of 4 μm, a nickel layer having a thickness of 2 μm and a tin layer having a thickness of 6 μm. The electroplated composite layer on the side is located at ⅙ position from an upper surface of the inductor to a side thereof, calculated from top to bottom.

The inductor of the third comparison example is the same as that of the first embodiment.

### A Fourth Comparison Example

A composite material is used to manufacture a magnetic member which the composite material is comprised of 95 wt % of alloy powder, 4 wt % of epoxy resin, 0.3 wt % of silane coupling agent, and 0.7 wt % of zinc stearate. The alloy powder is FeSiCr-C soft magnetic alloy powder produced by Advanced Technology & Materials Co., Ltd (AT&M).

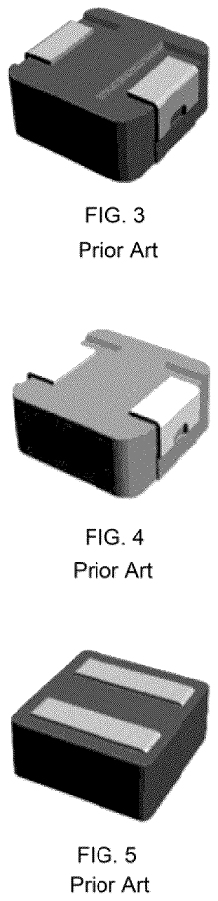

The inductor of the fourth comparison example is the A series inductor shown in FIG. 3 and is manufactured by the conventional manufacturing process. In detail, the composite material is uniformed mixed by means of the process of the first embodiment. Coil is placed in the mold. The mold is filled with the composite material. The material is compacted at a pressure of 6.0T/cm² for 3 sec.

### A Fifth Comparison Example

A composite material is used to manufacture a magnetic member which the composite material is comprised of 95 wt % of carbonyl iron powder, 4 wt % of epoxy resin, 0.3 wt % of silane coupling agent, and 0.7 wt % of zinc stearate. The alloy powder is FeSiCr-C soft magnetic alloy powder produced by Advanced Technology & Materials Co., Ltd (AT&M).

The inductor of the fifth comparison example is the B series inductor shown in FIG. 4 and is manufactured by the conventional manufacturing process. In detail, the composite material is uniformed mixed by means of the process of the first embodiment. Coil is placed in the mold. The mold is filled with the composite material. The material is compacted warmly at a temperature of 160/cm², at a pressure of 5.0T/cm² for 8 sec.

### A Sixth Comparison Example

A composite material is used to manufacture a magnetic member which the composite material is comprised of 95 wt % of carbonyl iron powder, 4 wt % of epoxy resin, 0.3 wt % of silane coupling agent, and 0.7 wt % of zinc stearate.

The inductor of the fifth comparison example is the C series inductor shown in FIG. 5 and is manufactured by the conventional manufacturing process. In detail, the composite material is uniformed mixed by means of the process of the first embodiment. The material is compacted by PM at a room temperature, at a pressure of 4.0T/cm² for 2 sec. Wire is wound on the T-core and the T-core is then placed in the mold. The mold is filled with the composite material. The material is compacted warmly at a temperature of 160/cm², at a pressure of 5.0T/cm² for 60 sec.

Performance of the inductors manufactured by the first to third embodiments and the first to sixth comparison examples is tested as follows:

Inductance and current measurements: An LCR test device is used to test a sample inductor, set parameters in which frequency is 1 MHz, and a biased current (i.e., initial conductance). As a result, inductance and current are measured.

Energy loss: CHROMA1810 test device is used to test energy loss in which test parameter setting is 100 mT and frequency is 100 KHz.

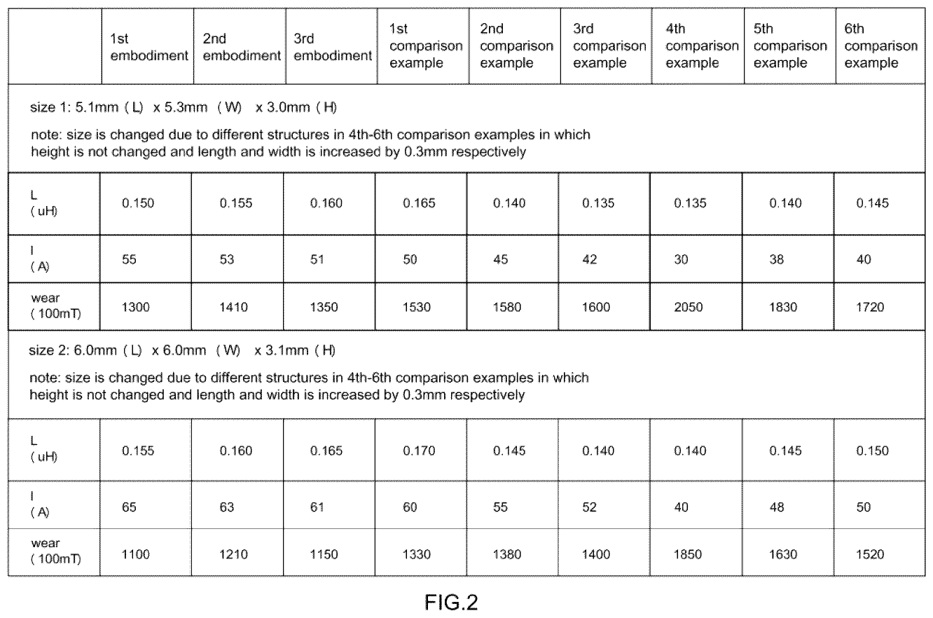

Performance test results of the inductors in terms of inductance, current and energy loss are tabulated in FIG. 2.

The invention has the following advantages and benefits in comparison with the conventional art:

A specific composite material is used and a specific cool shaping technology is chosen to cooperate with the specific composite material. T-core and U-core are prepared. The coil is placed in the cavity of the U-core. The projection of the T-core is placed in the through hole of the coil. The cavity of the U-core is covered by the platform. Heat shaping technology is used to form a half-finished product. The inductor of the invention is without drawbacks of the conventional inductor including low density, deformation, poor performance and high energy loss. A number of heating periods of time are used to heat the half-finished product. Thus, the inductor of the invention has a decreased probability of being cracked, and is without the problem of being subject to thermal expansion due to quick high temperature curing.

While the invention has been described in terms of embodiments, those skilled in the art will recognize that the invention can be practiced with modifications within the spirit and scope of the appended claim.

What is claimed is:

1. A process of manufacturing inductor, comprising the steps of:
preparing coil by winding a rectangular magnetic copper wire to form a coil having two parallel extensions in a horizontal direction, bending the extensions to dispose vertically with respect to the coil, and removing insulation layer of the magnetic copper wire from the extensions;
using a composite material to prepare a T-core and a U-core by adding epoxy resin and coupling agent to a solution to form a first mixture, adding carbonyl iron powder and amorphous powder to the first mixture, agitating the first mixture to form a second mixture, processing the second mixture to form a plurality of particles, adding zinc stearate to the particles to form a third mixture, pouring the third mixture into a mold, and the third mixture is compacted at a second predetermined temperature and a third predetermined pressure for a third predetermined time to form the T-core and the U-core wherein the T-core includes a platform and a projection extending downward from the platform and the U-core includes a cavity on a top;
disposing the coil in the cavity of the U-core with the extensions disposed externally of the cavity;
inserting the projection through the coil with the cavity being covered by the platform;
bending the extensions;
heating the assembled U-core, the coil, and the T-core at a second predetermined temperature and a second predetermined pressure for a second predetermined time to form a half-finished product;
baking the half-finished product at a third predetermined temperature for a third predetermined time;
painting and peeling the baked half-finished product; and
surface treating the peeled half-finished product by coating a composite layer on exposed surfaces of the extensions to obtain an inductor wherein the composite layer includes, from inside to outside, a copper layer, a nickel layer, and a tin layer.

2. The process of claim 1, wherein the second predetermined temperature is between 160° C. and 180° C., the second predetermined pressure is between 5.0T/cm² and 6.0T/cm², and the second predetermined time is between 50 sec and 80 sec.

3. The process of claim 1, wherein the compaction is at the third predetermined pressure of 3.5T/cm² to 4.0T/cm² for the third predetermined time of 1 sec to 2 sec.

4. The process of claim 1, wherein the copper layer has a thickness of 2 μm to 4 μm, the nickel layer has a thickness of 1 μm to 3 μm, and the tin layer has a thickness of 6 μm to 8 μm.

5. The process of claim 1, wherein the half-finished product is baked at the third predetermined temperature for the third predetermined time at eight periods, and wherein at a first period the third predetermined temperature is 80±5° C. and the third predetermined time is 30±3 min, at a second period the third predetermined temperature is 100±5° C. and the third predetermined time is 30±3 min, at a third period the third predetermined temperature is 120±5° C. and the third predetermined time is 30±3 min, at a fourth period the third predetermined temperature is 140±5° C. and the third predetermined time is 30±3 min, at a fifth period the third predetermined temperature is 160±5° Cand the third predetermined time is 120±3 min, at a sixth period the third predetermined temperature is 140±5° C. and the third predetermined time is 15±3 min, at a seventh period the third predetermined temperature is 120±5° C. and the third predetermined time is 15±3 min, and at an eighth period the third predetermined temperature is 100±5° C. and the third predetermined time is 15±3 min.
